(19) United States
(12) Patent Application Publication
(10) Pub. No.: US 2003/0149633 A1
(43) Pub. Date: Aug. 7, 2003

(54) Sales order process and system

(76) Inventor: James W. McConnell, Bayonet Point, FL (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/068,149

(22) Filed: Feb. 6, 2002

(51) Int. Cl. G06F 17/60

(52) U.S. Cl. 705/24

(57) ABSTRACT

A plurality of user interface devices 12, a plurality of product delivery stations 14, a plurality of delivery station display devices 16, a plurality of delivery attendant output devices 20, and a main computer 22 in communication with the user interface devices 12, the delivery station display devices 16, and the delivery attendant output devices 20. The user interface devices 12 receive the orders and payments from customers directly without needing an order-taking attendant, and the computer 22 sends the orders and associated identifiers to one of the delivery station display devices 16 and one of the delivery attendant output devices 20. The customers then match the identifier with the corresponding identifier displayed on the delivery station display devices 16 to determine at which of the delivery stations 14 to pick up their ordered products.

### TECHNICAL FIELD

This invention relates generally to processing sales orders from customers and, more particularly in an exemplary embodiment, to receiving food orders and payments from carryout and/or drive-through customers of restaurants without the need for a restaurant attendant, then quickly and efficiently fulfilling the food orders.

### BACKGROUND OF THE INVENTION

In today's hectic world, time is very valuable. To save time on the everyday task of preparing meals, many people eat at or carry food home from fast food restaurants and super market delis. For example, many parents routinely pick up prepared meals for their families on their way home from work. The cumulative time saved by this routine allows for significantly more time spent together as a family.

The restaurants that people choose to pick up prepared meals at are usually much faster at processing food orders than most sit-down restaurants. In part, this is because these restaurants serve food that can be prepared quickly and/or kept relatively tasty for some time. For example, these restaurants typically serve food such as hamburgers, fried chicken, rotisserie chicken, submarine sandwiches, Mexican food, Chinese food, pizza, and so forth.

Additionally, these restaurants can quickly process food orders because they are set up with drive-through and/or carry-out service. The order processing at these restaurants typically involves numerous attendants that take the customers'food orders, accept the customers'payment, and return change. Then cooks in a separate area prepare the meals, and the attendants deliver the food to the corresponding customers. In some restaurants, there are even different types and locations of attendants: some that take the orders and handle the payments and others that deliver the prepared food to the customers.

But even with numerous attendants, customers usually have to wait in line to place their order during the peak dinnertime hours of about 5 to 7 p.m. Oftentimes the wait is caused by there not being enough attendants working during this short peak time. Restaurants can't staff merely for the short peak times, however, or then they will have too many employees before the peak and/or after it subsides. And where separate order-taking and food pick-up locations are provided, whether inside or outside at the drive-through, the separate locations are arranged in series. So customers end up having to wait in line, inside the restaurant or outside at the drive-through, just to place their order with one of the attendants. It goes without saying that the sooner the customer's order is taken the sooner he or she can be served. So while these food order processing systems save customers time relative to typical sit-down restaurants, they nevertheless often involve a too-long wait for customers anxious to get home to have dinner with their families.

Accordingly, a need remains in the art for a food order processing system that permits faster customer turnaround times. Also, there is a need for such a system that can be used for receiving food orders and payment from carryout and/or drive-through customers without the need for a restaurant attendant. Additionally, there is a need for such a system that permits the food ordered to be prepared more quickly and efficiently. Furthermore, such a system is needed that is economical to implement and operate without sacrificing the quality of the food served. It is to the provision of such a food order processing system that the present invention is primarily directed.

### SUMMARY OF THE INVENTION

Briefly described, in an exemplary form the present invention includes a sales order processing system for receiving product orders and order payments from customers, and then presenting the ordered products to the respective customers. The products ordered can include, for example, food products such as rotisserie chicken and the usual side dishes. Of course, orders for other products can be processed by the system.

The system includes a plurality of user interface devices, a plurality of product delivery stations, a plurality of delivery station display devices, a plurality of delivery attendant output devices, and a main computer. The computer communicates by wires, wireless systems, or otherwise with the user interface devices, the delivery station display devices, and the delivery attendant output devices.

The user interface devices include order entry devices to receive the orders and order payment devices to receive payments from customers directly without needing an order-taking attendant. For example, the user interface devices can be provided by touch screens or the like, and the order payment devices can be provided by credit card, debit card, or cash machines. Advantageously, the user interface devices receive and process payment for the orders without the need for an order-taking attendant. In this way, the customers can place their orders more quickly, without having to wait in line for an available order-taking attendant.

Also, the computer is programmed to send the orders and associated identifiers to one of the delivery station display devices and one of the delivery attendant output devices. The delivery station display devices and the delivery attendant output devices can be provided by, for example, video monitors or the like. Also, the computer can be programmed to send the orders to the delivery station display device with the fewest number of unfulfilled orders. In this way, the food products can be prepared and delivered to the customers more quickly.

Additionally, the user interface devices provide tickets with identifiers such as order numbers and/or delivery station numbers marked on them. In this way, the customers can match the identifier on their ticket with the corresponding identifier displayed on one of the delivery station display devices to determine at which of the delivery stations to pick up their ordered products.

Accordingly, the customers can place their orders and pay for them by themselves, without having to wait in line for an order-taking attendant to do so. Then the products can be prepared quickly in an assembly line-type process, and the customers can pick-up the products they ordered with a minimal wait, if any. In this way, the system provides for more efficient entering and processing of the orders so that the customers can be on their way sooner.

### BRIEF DESCRIPTION OF THE DRAWING FIGURES

FIG. 1 is a block diagram of a sales order processing system of a first exemplary embodiment of the present invention.

FIG. 2 is a front view of a sales ticket produced by the system of FIG. 1, showing an identifier provided by an order identifier.

FIG. 2A is a front view of an alternative sales ticket, showing the identifier provided by a delivery station identifier.

FIG. 3A is a front view of a sales ticket produced by the system of FIG. 1, showing payment indicia indicating that the payment has not been received.

FIG. 3B is a front view of a secondary sales ticket produced by the system of FIG. 1, showing the payment indicia indicating that the payment has been received.

FIG. 4 is a flow diagram of a sales order processing method of a second exemplary embodiment of the present invention.

### DETAILED DESCRIPTION OF THE EXEMPLARY EMBODIMENTS

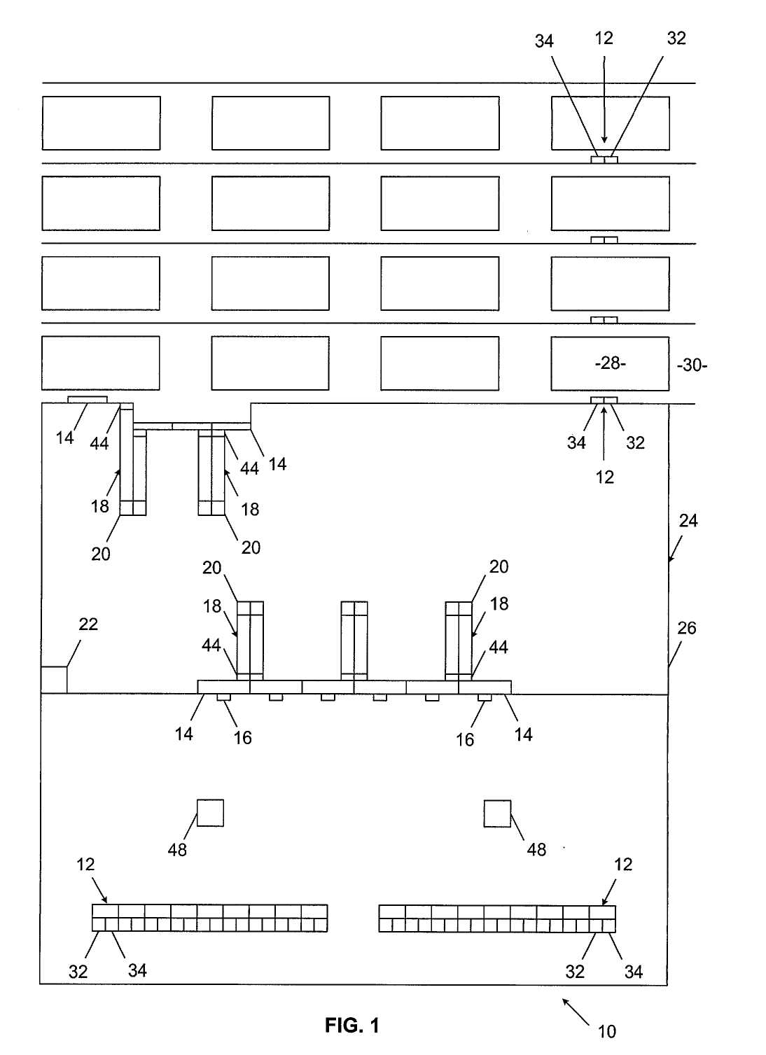

Referring now to the drawing figures, wherein like reference numerals represent like parts throughout the several views, FIG. 1 shows a sales order processing system 10 of a first exemplary embodiment of the present invention. The system 10 provides for receiving product orders and order payments from customers, and then presenting the ordered products to the respective customers. The products ordered can include, for example, food products such as rotisserie chicken and the usual side dishes. In using the system 10, the customers can place their orders and pay for them by themselves, without having to wait in line for an order-taking attendant to do so. Then the products can be prepared quickly in an assembly line-type process, and the customers can pick-up the products they ordered with a minimal wait, if any. In this way, the system 10 provides for more efficient entering and processing of the orders so that the customers can be on their way sooner.

The system 10 includes a plurality of user interface devices 12, a plurality of product delivery stations 14, a plurality of delivery station display devices 16, a plurality of product preparation zones 18, a plurality of delivery attendant output devices 20, and a main computer 22. The main computer 22 is configured to communicate with the user interface devices 12, the delivery station display devices 16, and the delivery attendant output devices 20, and is programmed to correlate the orders received by the user interface devices 12 with the product delivery stations 14. Also, each one of the product delivery stations 18 can have one of the delivery station display devices 16, product preparation zones 18, and delivery attendant output devices 20 dedicated to it, with each group of these components forming an assembly line for preparing the products.

Additionally, the system 10 is used in a building 24 having walls 26 that form, in this embodiment, a restaurant building. The delivery station display devices 16, product preparation zones 18, delivery attendant output devices 20, and main computer 22 are housed in the building 24. At least some of the user interface devices 12 and product delivery stations 14 can be housed in the building for serving carryout or eat-in customers. Also, the system 10 can be configured for drive-through service to customers in their cars 28 or other vehicles as they progress through vehicle lanes 30. Thus, at least some of the user interface devices 12 can be disposed outside of the building and adjacent the lanes 30, and at least some of the product delivery stations 14 can be placed outside the building or on or through the walls so as to be accessible from outside of the building. Of course, the system 10 can be used for providing carryout service only, eat-in service only, drive-though service only, or a combination of these.

Each of the user interface devices 12 can include an order entry device 32 and a payment processing device 34. The order entry devices 32 and the payment processing devices 34 can be arranged integrally or, if desired, they can be positioned proximate to each other, spaced apart, or otherwise arranged. Also, any number of the user interface devices 12 can be provided, and they can be arranged adjacent to each other in a linear or curved row, several of them can be grouped together into pods, or they can be spaced apart, whichever is desired in a particular application given the space limitations and number of expected customers.

The order entry devices 32 are configured to receive the orders from the customers directly without needing an order-taking attendant. Thus, the order entry devices 32 can include touch screen monitors, keyboards or keypads, voice recognition systems, a combination of these, or other devices for entering the orders. Also, the order entry devices 32 can be configured to receive the orders by wireless transmissions from customers'cell phones or PDA's in their cars as they approach the restaurant.

The payment processing devices 34 are configured to receive and process at least some of the order payments from the customers directly without needing an ordertaking attendant. Thus, the payment processing devices 34 can include conventional processors for credit cards and debit cards with a modem in communication with the card issuer's authorization system, processors for receiving cash and delivering change, or a combination of these. Alternatively, the payment processing devices 34 can include processors for payment or discounts by smart cards or special-issue cards issued by the restaurant (e.g., for frequent customers, gift certificates, etc.).

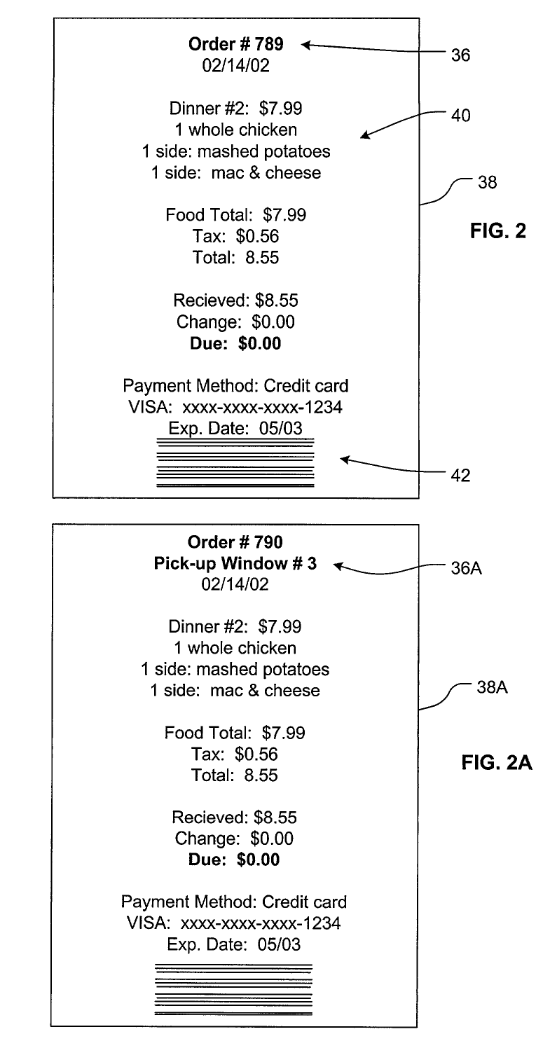

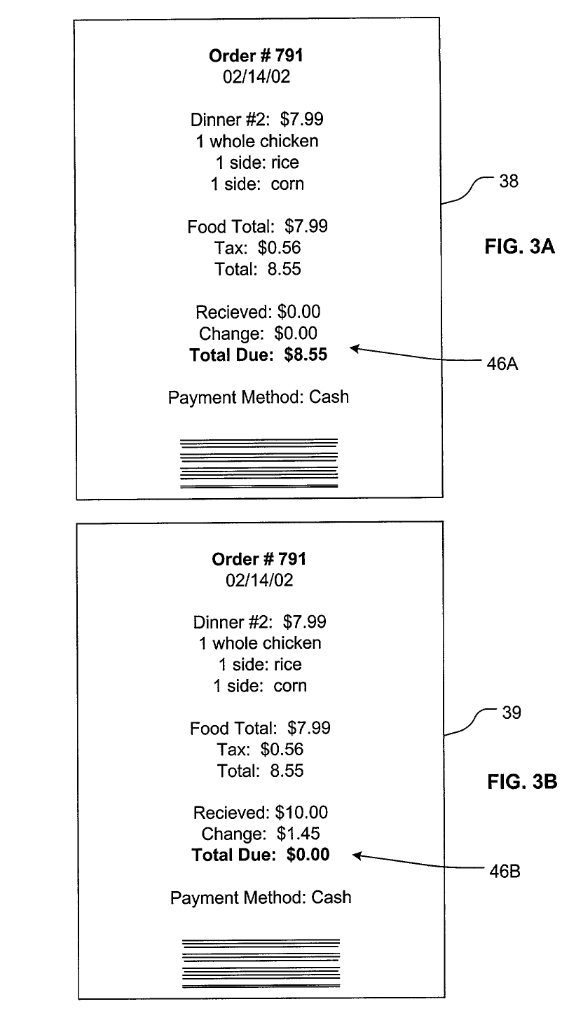

The user interface devices 12 are configured to output to the customers tickets with identifiers associated therewith and corresponding to the orders. For example, the user interface devices 12 can be provided with or connected to printers that print tickets made of paper or another material. Alternatively, the tickets can be provided by tokens such as chips, pagers, or other items, each with one of the identifiers marked thereon. Additional details of the tickets are provided below with reference to FIGS. 2-3B.

The product delivery stations 14 permit presenting the ordered products to the customers. Thus, the product delivery stations 14 can include windows, booths, counters, or the like, where the customers can pick-up their ordered products. Any number of the product delivery stations 14 can be provided, and they can be arranged adjacent to each other in a linear or curved row, several of them can be grouped together into pods, or they can be spaced apart, whichever is desired in a particular application given the space limitations and number of expected customers. Also, for the drive-through service, the product delivery stations 14 can be arranged to permit drive-through attendants to pick up the ordered products and carry them to the respective customers in their cars 28.

The product delivery stations 14 and the user interface devices 12 need not correlate in a one-to-one relationship, which allows for fulfillment of the orders by the product preparation zones 18 that can do so the quickest. Thus, the product delivery stations 14 are spaced apart from the user interface devices 12 some distance to allow the customers to move from the user interface devices 12 to the product delivery stations 14 without undue congestion.

The delivery station display devices 16 are configured to display to the customers the identifiers on their tickets. For example, the delivery station display devices 16 can be provided by video monitors or other variable display devices that can display data for some time and then remove it. In this way, the customers can match the identifiers on their tickets with the identifiers displayed on the display devices 16 to determine at which of the delivery stations 14 to pick up their ordered products. Additional details of the identifiers are provided below with reference to FIG. 2.

The product preparation zones 18 can be provided by counters or the like that hold the food or other products. The products can be arranged in or on the counters for easy access and efficient packaging by product delivery attendants.

The delivery attendant output devices 20 are configured to output to the product delivery attendants the orders and the identifiers. For example, the delivery attendant output devices 20 can be provided by video monitors or other variable display devices that can display data for some time and then remove it. Alternatively, the delivery attendant output devices 20 can be provided by printers that print a copy of the order and identifier to the product delivery attendants. Other output devices can be suitably employed.

The main computer 22 can be provided by a conventional computer with a processor and memory that is configured as a file server, as is known in the art. The programming for the computer may be stored on a computer-readable storage medium such as a magnetic tape drive, a diskette or disc readable by a magnetic or optical drive, flash memory devices, or the like. Also, a back-up storage device and an uninterruptible power source can be provided, as may be desired. The computer 22 communicates with the user interface devices 12, the delivery attendant output devices 20, and the delivery station display devices 16 by wires, wireless systems, or otherwise.

As mentioned above, the main computer 22 is programmed to correlate the orders received by the user interface devices 12 with the product delivery stations 14. For example, the computer 22 can be programmed to receive the orders and identifiers from the user interface devices 12 and to send them to the delivery attendant output devices 20 and the delivery station display devices 16. Additionally, the main computer 22 can be programmed to assign the identifiers to the orders, to track the orders, to compile various reports for the orders, and so forth.

Furthermore, the computer 22 can be programmed to monitor the delivery attendant output devices 20 (including other devices in communication with the delivery attendant output devices 20, directly or via the computer 22) to determine which of the product preparation zones 18 has the fewest number of orders that are unfulfilled, and to assign the orders and identifiers to the delivery attendant output devices 20 associated with those product preparation zones 18 and product delivery stations 14. In this way, the orders can be fulfilled by the preparation zones 18 that can do so most quickly and efficiently, thereby reducing or eliminating the amount of time that the customers wait to get their products.

Also, one or more of the order entry devices 12 can be dedicated to one or more of the product delivery stations 14. For example, one of the drive-through lanes 30, say, the lane closest to the building 24, can have its order entry device 12 dedicated to one of the product delivery stations 14. Even if that product delivery station 14 were to back up from a large order or for an order that otherwise will take longer to fulfill, the orders for the next-in-line cars 28 can be prepared by one of the other product preparation zones 18 and delivered to them. In this way, once the lead car 28 has pulled away from that product delivery station 14, the following cars are also ready to pull out. Alternatively, an exit lane can be provided between two of the lanes 30 so that these cars can leave when they receive their ordered products from the drive-through attendants.

Referring additionally to FIG. 2, the identifiers can comprise order identifiers 36 such as numbers, letters, a combination thereof, or other designations that uniquely identify the order. The order identifiers 36 are printed or otherwise marked on the tickets 38, and, if desired, the orders 40 (i.e., the ordered products) and/or other data can also be marked on the tickets. As mentioned above, these order identifiers 36 are also sent to the delivery station display devices 16. In this way, the customers can match the order identifiers 36 on their tickets 38 to the order identifiers displayed on the delivery station display devices 16 to determine at which of the delivery stations 14 to receive their respective ordered products.

Additionally, the tickets 38 can have codes 42 on them and the system 10 can include code readers 44 in communication with the main computer 22, positioned proximate to the delivery stations 14, and configured to read the codes. For example, the codes 42 can be conventional bar codes and the code readers 44 can be provided by conventional bar code scanners. Alternatively, the codes 42 can include numeric, alphanumeric, or other designations, the same as or different from the order identifiers 36, and the code readers 44 can include scanners or other readers for these designations. The main computer 22 is programmed to remove the identifiers 36 from the delivery station display devices 16 when the delivery attendants scan the codes 42 on the customers'tickets with the readers 44. In this way, only the orders that are currently unfulfilled are displayed on the display devices 16.

Alternatively, referring to FIGS. 1 and 2A, the delivery station display devices 16 can be provided by fixed indicia each associated with one of the delivery stations 14, and the identifiers on the tickets 38A can include delivery station indicia 36A corresponding to one of the delivery stations. For example, the delivery station display devices 16 can be provided by signs displaying delivery station indicia 36A such as numbers, letters, or other designations that uniquely identify the delivery stations 14. In this way, the customers can match the delivery station indicia 36A on with their tickets 38A to the corresponding delivery station indicia displayed at the delivery stations 14 to determine at which of the delivery stations to receive their respective ordered products.

Referring now to FIGS. 1, 3A, and 3B, the tickets 38 can additionally include payment indicia 46A and 46B indicating whether or not the payment has been received, and the system 10 can further include one or more conventional cashier stations 48 in communication with the computer 22 and configured to receive and process the order payments in cash or otherwise. For example, as shown in FIG. 3A, the user interface devices 12 can be configured to mark the tickets 38 with the payment indicia being a cash amount due 46A when the order payment has not been received.

The customers can then proceed to one of the cashier stations 48 to pay for their order. The cashier stations 48 can be configured to input the codes, identifiers, and/or payment indicia, for example, by scanning the ticket with a bar code reader to bring up the order and payment details on a cashier screen. The cashier attendant then receives the customer's payment and returns the appropriate change. As shown in FIG. 3B, the cashier stations 48 can be configured to output a secondary ticket 39 with the identifier and the payment indicia 46B indicating that the payment has been received. In this manner, the cashier attendant need not do anything but enter the amount tendered and give the customer change and a new ticket (while discarding the old ticket), so that the cashier's job is simplified, errors are reduced, and speed is increased.

Alternatively, the cashier stations 48 can be configured to allow a cashier attendant to manually or electronically mark the original tickets 38 with payment indicia such as a “paid” stamp to indicate that the payment has been received. The customer can then take the secondary ticket 39 (or the original ticket 38, as may be the case) with the payment indicia 46B indicating that payment has been received to the corresponding delivery station 14 to get their food. In any event, the customer is preferably provided with only one ticket at a time to prevent inadvertent or intentional duplication of orders and/or confusion by the customers.

Also, the computer 22 can be programmed to assign the order identifier 36, correlate it to one of the product delivery stations 14, and/or send it to one of the delivery station display devices 16 at this point after payment has been received, instead of at the order entry point, as may be desired. In this case, the cashier station can be equipped with a scanner to scan the codes 42 to call-up and display on a cashier station screen the order and the payment and change amount due. Alternatively, the identifiers for the cash orders can be listed on the screen and the cashier can select a desired order on the screen for processing the payment.

In an alternative embodiment, the products include a plurality of different types of food products, for example, chicken, turkey, and ham. Each of the product preparation zones 18 and the product delivery stations 14 can be arranged to prepare and deliver only one or more of the types of products, and the main computer 22 can be programmed to send the orders to the delivery attendant output devices 20 set up for the type of product ordered. Thus, several of the product preparation zones 18 can be dedicated to fulfilling orders for high volume items such as chicken, while fewer of the product preparation zones 18 can be dedicated to fulfilling orders for lower volume items such as turkey and ham. The main computer 22 can be programmed to send chicken orders to one of the delivery attendant output devices 20 for the chicken product preparation zones 18, and to send orders for turkey or ham to the corresponding delivery attendant output devices 20. Of course, the main computer 22 can be programmed this way in addition to as described above, so that the chicken orders are sent to the delivery attendant output device 20 for chicken orders that has the fewest unfulfilled orders. In this way, further efficiencies can be attained in processing the customers'orders.

In another embodiment, instead of the plurality of the delivery station display devices 16 each positioned proximate to and dedicated to one of the delivery stations 14, only one (or some other number) of them are provided for displaying the identifiers for all of the orders. In this manner, the customers can look to one place, at this central display device 16, to find out which delivery station to go to.

In still other embodiments, the system 10 can be adapted to process rental and/or other types of orders in addition or as an alternative to processing sales orders. In these forms, the system can include customer identification cards each with an identification number associated with one of the customers, additional records for tracking the rental products currently on loan to a customer, and return locations for customers to return the rented products.

In yet further embodiments, the system 10 is adapted to process orders for video products, music products, vehicle fuel, convenience store items, sundries, and so forth, in addition to or as an alternative to processing orders for food products. In these forms, the building can include additional product storage space, as may be desired.

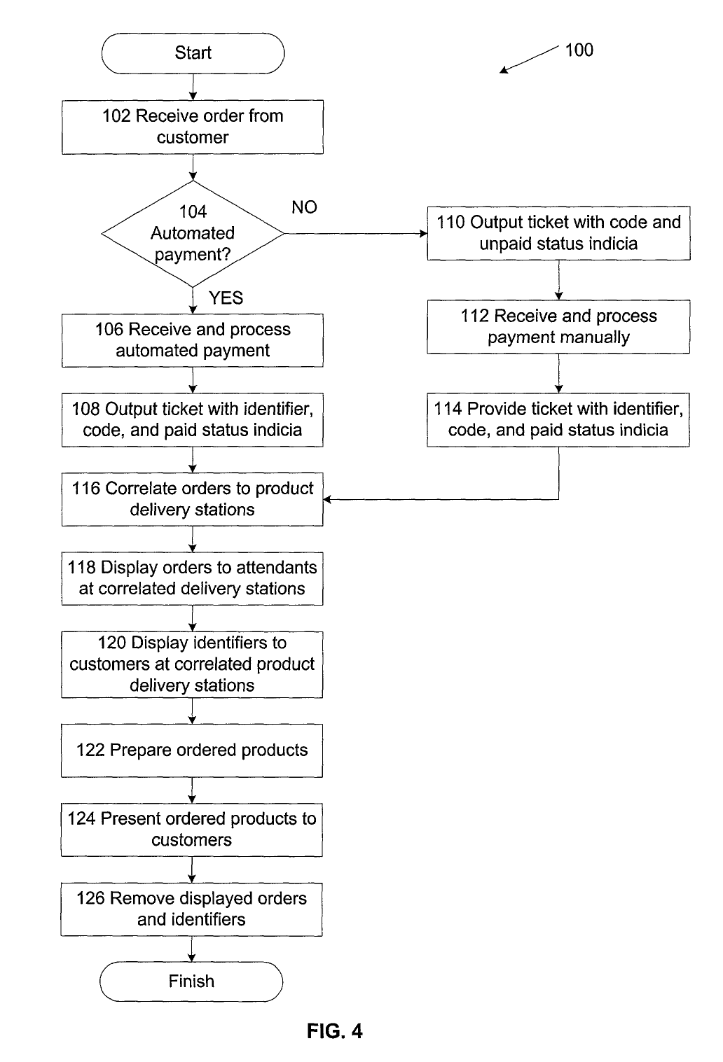

Referring now to FIG. 4, the present invention includes a method of processing orders for products from customers, generally referred to as the method 100. The method 100 can be implemented using the above-described system 10 or otherwise.

The method 100 includes at step 102 receiving the orders from the customers directly without an order-taking attendant. For example, the orders can be received from the customers into order entry devices such as touch screen terminals.

At step 104, the customers elect whether to make an automated payment for their orders directly without an order-taking attendant or to pay manually at a cashier station. If the customer elects to make an automated payment, then at 106 the payment for that order is received and processed directly. For example, the direct/automated order payments can be received from the customers into and processed by payment processing devices including cash, credit card, or debit card processors.

Then at 108, a ticket with an identifier, payment status indicia, code, and/or other data is output to the customer. For example, paper tickets can be printed by printers electrically connected to or integrally formed with the order entry devices and/or the payment processing devices. The identifiers are selected to correspond to the orders, and can be provided by, for example, unique order numbers or delivery station indicia. The payment status indicia indicate that payment has been received, and the codes can be bar codes or other codes.

If, however, the customer elects to pay indirectly/manually at 104, then at 110 a ticket is output with a unique code and a payment status indicia indicating that payment has not been received. Then at 112 payment for that order is received and processed manually at a cashier station. This can include the cashier scanning the ticket with a bar code reader to bring up the order and payment details on a cashier screen, receiving the appropriate payment in cash or another form, and returning any change due.

Then at 114, a second ticket is output to the customer by the cashier station. The second ticket can include an identifier (similar to that described above), the code, and payment status indicia indicating that payment has now been received. Alternatively, the original ticket can be marked with the identifier and the updated payment status indicia. Also, the identifier can be assigned upon receipt of payment or upon order entry, as may be desired.

Regardless of how the payment is received, at 116 the orders are correlated to product delivery stations for presenting the ordered products to the customers. The particular product delivery station selected can be the one having the fewest number of unfulfilled orders. In this way, the orders can be fulfilled efficiently and presented to the customers at the delivery stations best suited to do so quickly. At 118 the orders and identifiers are then sent to and displayed on (or otherwise output by) delivery attendant output devices associated with selected product delivery stations.

Also, where the identifiers are order identifiers, at 120 they can be sent to and displayed on delivery station display devices (e.g., video monitors) associated with the product delivery stations. In this way, the customers can match the identifiers on their tickets to the corresponding delivery station display devices to determine at which of the delivery stations to receive their respective ordered products. Alternatively, where the identifiers are delivery station indicia, then the identifier is selected in conjunction with the selection of the product delivery station, as just described.

Then at 122, the products are prepared by attendants based on the orders output by the delivery attendant output devices, and at 124 presented to the customers at the corresponding delivery stations. Also, at 126, the customers'tickets can be scanned to read the codes, and the identifiers can then be removed from the delivery station display devices.

Accordingly, the orders can be received from the customers without the need for order-taking attendants, thereby eliminating or at least reducing the wait for customers to place their orders. Also, the programming of the computer permits the ordered products to be prepared by the product preparation zone that can most quickly fulfill the orders, and the arrangement of the product preparation zones permits the orders to be fulfilled in a more efficient manner, thereby eliminating or at least reducing the wait for customers to receive their orders. Accordingly, the present invention as described in the above-detailed embodiments provides for more quickly and efficiently processing customer orders relative to the known prior art systems and methods.

In the embodiments described above and the following claims, the use of a singular or plural form of a term is not intended to limit the term to that form. For example, the words “a,” “an,” and “one” are not intended to mean “only one” but can also mean “more than one.” Also, the method steps described herein are not intended to be limited to the specific sequences described but can be carried out in other sequences. Furthermore, while the invention has been disclosed in exemplary forms, those skilled in the art will recognize that many modifications, additions, and deletions can be made therein without departing from the spirit and scope of the invention as set forth in the following claims.

What is claimed is:

1. A system for receiving product orders and order payments from customers and presenting ordered products to the respective customers, the system comprising:
a) a plurality of order entry devices configured to receive the orders from the customers directly without needing an order-taking attendant;
b) a plurality of payment processing devices configured to receive and process at least some of the order payments from the customers directly without needing an order-taking attendant;
c) a plurality of product delivery stations adapted for presenting the ordered products to the customers; and
d) a main computer in communication with the order entry devices and the payment processing devices, wherein the main computer is programmed to correlate the orders with the product delivery stations.

2. The system of claim 1, further comprising one or more delivery station display devices, wherein the order entry devices or the payment processing devices are configured to output to the customers tickets with identifiers associated therewith and corresponding to the orders, and the delivery station display devices are configured to display to the customers the identifiers, wherein the customers can match the identifiers associated with their tickets to the corresponding delivery station display devices to determine at which of the delivery stations to receive their respective ordered products.

3. The system of claim 2, wherein the identifiers comprise order identifiers and the delivery station display devices comprise variable display devices in communication with the main computer and configured to display the order identifiers, wherein the customers can match the order identifiers associated with their tickets to the order identifiers displayed on the delivery station display devices to determine at which of the delivery stations to receive their respective ordered products.

4. The system of claim 3, wherein the tickets have codes associated therewith, and further comprising code readers configured to read the codes, disposed proximate to each of the delivery stations, and in communication with the main computer, wherein the main computer is programmed to remove the order identifiers from the delivery station display devices in response to the codes being read by the code reader.

5. The system of claim 2, wherein the delivery station display devices comprise fixed indicia associated with the delivery stations and the identifiers comprise the delivery station indicia, wherein the customers can match the delivery station indicia associated with their tickets to the delivery station indicia associated with the delivery stations to determine at which of the delivery stations to receive their respective ordered products.

6. The system of claim 2, wherein the one or more delivery station display devices comprises a plurality of delivery station display devices with each one of them disposed proximate to one of the delivery stations.

7. The system of claim 2, further comprising a plurality of delivery attendant output devices and a plurality of product preparation zones arranged with each one of the delivery attendant output devices associated with one of the product preparation zones and one of the product delivery stations, wherein the delivery attendant output devices are configured to output to product delivery attendants the orders and the identifiers.

8. The system of claim 7, wherein the main computer is programmed to send the orders to the delivery attendant output devices associated with the product delivery stations having a fewest number of orders that are unfulfilled.

9. The system of claim 7, wherein the products comprise a plurality of different types of products, each of the product delivery stations are arranged to deliver one or more of the types of products, and the main computer is programmed to send the orders to the delivery attendant output devices associated with the type of product ordered.

10. The system of claim 2, wherein the tickets include payment indicia indicating whether or not the payment has been received, and further comprising one or more cashier stations in communication with the main computer and configured to receive and process order payments in cash and configured to mark the tickets with the payment indicia indicating that the payment has been received or to output a secondary ticket having associated therewith the identifier and the payment indicia indicating that the payment has been received.

11. The system of claim 2, further comprising a building, wherein at least some of the customers are carryout or eat-in customers, and wherein at least some of the order entry devices, at least some of the payment processing devices, at least some of the product delivery stations, at least some of the delivery station display devices, and the main computer are housed inside of the building, wherein the system is arranged for use by the carryout or eat-in customers.

12. The system of claim 2, further comprising a building and a row of vehicle lanes, wherein at least some of the customers are drive-through customers, and wherein the main computer is housed inside of the building, at least some of the order entry devices and at least some of the payment processing devices are disposed outside of the building and adjacent the lanes, and at least some of the product delivery stations are accessible from outside of the building, wherein the system is arranged for use by the drive-through customers.

13. A system for receiving product orders and order payments from customers and presenting ordered products to the respective customers, the system comprising:
a) a plurality of user interface devices each including an order entry device and a payment processing device, wherein the order entry devices are configured to receive the orders from the customers and the payment processing devices are configured to receive and process at least some of the order payments, wherein the user interface devices are configured to output to the customers tickets with identifiers associated therewith and corresponding to the orders;
b) a plurality of product delivery stations adapted for presenting the ordered products to the customers;
c) a plurality of delivery station display devices with each one disposed proximate to one of the delivery stations and configured to display to the customers the identifiers, wherein the customers can match the identifiers associated with their tickets to the corresponding delivery station display devices to determine at which of the delivery stations to receive their respective ordered products;
d) one or more delivery attendant output devices associated with the product delivery stations and configured to output to product delivery attendants the orders and the identifiers; and
e) a main computer in communication with the user interface device, the delivery station display devices, and the delivery attendant output devices, wherein the main computer is programmed to receive the orders and the order identifiers from the user interface and send the orders and the identifiers to the delivery station display devices and the delivery attendant output devices.

14. The system of claim 13, wherein the identifiers comprise order identifiers and the delivery station display devices comprise variable display devices in communication with the main computer and configured to display the order identifiers, wherein the customers can match the order identifiers associated with their tickets to the order identifiers displayed on the delivery station display devices to determine at which of the delivery stations to receive their respective ordered products.

15. The system of claim 14, wherein the tickets have codes associated therewith, and further comprising code readers configured to read the codes, disposed proximate to each of the delivery stations, and in communication with the main computer, wherein the main computer is programmed to remove the order identifiers from the delivery station display devices in response to the codes being read by the code reader.

16. The system of claim 13, wherein the delivery station display devices comprise fixed indicia associated with the delivery stations and the identifiers comprise the delivery station indicia, wherein the customers can match the delivery station indicia associated with their tickets to the delivery station indicia associated with the delivery stations to determine at which of the delivery stations to receive their respective ordered products.

17. The system of claim 13, wherein the tickets include payment indicia indicating whether or not the payment has been received, and further comprising one or more cashier stations in communication with the main computer and configured to receive and process order payments in cash and configured to mark the tickets with the payment indicia indicating that the payment has been received or to output a secondary ticket having associated therewith the identifier and the payment indicia indicating that the payment has been received.

18. The system of claim 13, wherein the order entry devices are configured to receive the orders from the customers directly without needing an order-taking attendant and the payment processing devices are configured to receive and process at least some of the order payments from the customers directly without needing an order-taking attendant.

19. The system of claim 13, further comprising a plurality of product preparation zones each one associated with one of the delivery stations, wherein the one or more delivery attendant output devices comprises a plurality of delivery attendant output devices with each one of them disposed proximate to one of the product preparation zones, and wherein the main computer is programmed to send the orders to the delivery attendant output devices associated with the product delivery stations having a fewest number of orders that are unfulfilled.

20. The system of claim 13, further comprising a plurality product preparation zones each one associated with one of the delivery stations, wherein the one or more delivery attendant output devices comprises a plurality of delivery attendant output devices with each one of them disposed proximate to one of the product preparation zones, the products comprise a plurality of different types of products, each of the product delivery stations are arranged to deliver one or more of the types of products, and the main computer is programmed to send the orders to the delivery attendant output devices associated with the type of product ordered.

21. A system for receiving product orders and order payments from customers and presenting ordered products to the respective customers, the system comprising:
a) a plurality of user interface devices each including an order entry device and a payment processing device, wherein the order entry devices are configured to receive the orders from the customers and the payment processing devices are configured to receive and process at least some of the order payments;
b) a plurality of product delivery stations adapted for presenting the ordered products to the customers;
c) a plurality of product preparation zones each one associated with one of the product delivery stations;
d) a plurality of delivery attendant output devices each one associated with one of the product preparation zones and configured to output to the product delivery attendants the orders and the identifiers; and
e) a main computer in communication with the user interface device and the delivery attendant output devices, wherein the main computer is programmed to receive the orders and the order identifiers from the user interface and send the orders and the identifiers to the delivery attendant output devices.

22. The system of claim 21, wherein each one of the product delivery stations is dedicated to one of the order entry devices.

23. The system of claim 21, wherein the main computer is programmed to send the orders to the delivery attendant output devices associated with the product delivery stations having a fewest number of orders that are unfulfilled.

24. The system of claim 21, wherein the products comprise a plurality of different types of products, each of the product delivery stations are arranged to deliver one or more of the types of products, and the main computer is programmed to send the orders to the delivery attendant output devices associated with the type of product ordered.

25. The system of claim 21, wherein the user interface devices are configured to output to the customers tickets with identifiers associated therewith and corresponding to the orders, and further comprising a plurality of delivery station display devices with each one disposed proximate to one of the delivery stations and configured to display to the customers the identifiers, wherein the customers can match the identifiers associated with their tickets to the corresponding delivery station display devices to determine at which of the delivery stations to receive their respective ordered products.

26. The system of claim 25, wherein the tickets include payment indicia indicating whether or not the payment has been received, and further comprising one or more cashier stations in communication with the main computer and configured to receive and process order payments in cash and configured to mark the tickets with the payment indicia indicating that the payment has been received or to output a secondary ticket having associated therewith the identifier and the payment indicia indicating that the payment has been received.

27. The system of claim 21, wherein the order entry devices are configured to receive the orders from the customers directly without needing an order-taking attendant and the payment processing devices are configured to receive and process at least some of the order payments from the customers directly without needing an order-taking attendant.

28. A system for receiving product orders and order payments from customers and presenting ordered products to the respective customers, the system comprising:
a) a plurality of user interface devices each including an order entry device and a payment processing device, wherein the order entry devices are configured to receive the orders from the customers directly without needing an order-taking attendant and the payment processing devices are configured to receive and process at least some of the order payments from the customers directly without needing an order-taking attendant, wherein the user interface devices are configured to output to the customers tickets with identifiers associated therewith and corresponding to the orders;
b) a plurality of product delivery stations adapted for presenting the ordered products to the customers;
c) a plurality of delivery station display devices each one associated with one of the product delivery stations and configured to display to the customers the identifiers;
d) a plurality of product preparation zones each one associated with one of the product delivery stations;
e) a plurality of delivery attendant output devices each one associated with one of the product preparation zones and configured to output to the product delivery attendants the orders and the identifiers; and
f) a main computer in communication with the order entry devices, the payment processing devices, the delivery station display devices, and the delivery attendant output devices, wherein the main computer is programmed to receive the orders and identifiers from the user interface devices and to send them to the delivery attendant output devices and the delivery station display devices associated with the product delivery stations having a fewest number of orders that are unfulfilled, wherein the customers can match the identifiers associated with their tickets to the corresponding delivery station display devices to determine at which of the delivery stations to receive their respective ordered products.

29. The system of claim 28, wherein the identifiers comprise order identifiers and the delivery station display devices comprise variable display devices in communication with the main computer and configured to display the order identifiers.

30. The system of claim 29, wherein the tickets have codes associated therewith, and further comprising code readers configured to read the codes, disposed proximate to each of the delivery stations, and in communication with the main computer, wherein the main computer is programmed to remove the order identifiers from the delivery station display devices in response to the codes being read by the code reader.

31. The system of claim 28, wherein the delivery station display devices comprise fixed indicia associated with the delivery stations and the identifiers comprise the delivery station indicia.

32. The system of claim 28, wherein the tickets include payment indicia indicating whether or not the payment has been received, and further comprising one or more cashier stations in communication with the main computer and configured to receive and process order payments in cash and configured to mark the tickets with the payment indicia indicating that the payment has been received or to output a secondary ticket having associated therewith the identifier and the payment indicia indicating that the payment has been received.

33. The system of claim 28, wherein the order entry devices comprise touch screen monitors and the payment processing devices comprise credit or debit card payment processors.

34. The system of claim 28, wherein the order entry devices are spaced apart from the product delivery stations.

35. The system of claim 28, wherein the order entry devices and the payment processing devices are configured integrally or disposed proximate to each other.

36. The system of claim 28, further comprising a building, wherein at least some of the user interface devices, at least some of the product delivery stations, the delivery station display devices, the product preparation zones, the delivery attendant output devices, and the main computer are housed inside of the building.

37. A method of processing orders for products from customers, the method comprising:
a) receiving the orders from the customers directly without an order-taking attendant;
b) receiving and processing payments for at least some of orders from the customers directly without an order-taking attendant;
c) outputting to the customers tickets with identifiers associated therewith and corresponding to the orders;
d) correlating the identifiers to delivery station display devices and delivery attendant output devices associated with product delivery stations;
e) displaying the identifiers on the delivery station devices, wherein the customers can match the identifiers associated with their tickets to the corresponding delivery station display devices to determine at which of the delivery stations to receive their respective ordered products;
f) outputting the orders by the delivery attendant output devices;
g) preparing the products based on the orders output by the delivery attendant output devices; and
h) presenting the ordered products to the customers at the corresponding delivery stations.

38. The method of claim 37, wherein correlating the identifiers comprises assigning them to the delivery attendant output devices and the delivery station display devices associated with the product delivery stations having a fewest number of orders that are unfulfilled.

39. The method of claim 37, wherein outputting the tickets with identifiers comprises assigning order numbers or delivery station indicia to the orders.

40. The method of claim 37, wherein outputting the tickets with identifiers includes assigning codes to the orders, and further comprising reading the codes and, in response thereto, removing the identifiers from the delivery station display devices.

41. The method of claim 37, wherein receiving and processing payments for at least some of the orders comprises receiving and processing payments by credit or debit cards.

42. The method of claim 41, wherein receiving and processing the payments further comprises including on the tickets payment indicia indicating whether or not the payments have been received by a credit or debit card, and if the payments have not been received by a credit or debit card, then further comprising receiving and processing payments by cash and either marking the tickets with the payment indicia indicating that the payment has been received or outputting a secondary ticket having associated therewith the identifier and the payment indicia indicating that the payments have been received.

43. The method of claim 37, wherein the orders are received from the customers into order entry devices, at least some of the order payments are received from the customers into and processed by payment processing devices, and the tickets are output to the customers by the order entry devices or the payment processing devices.

44. A computer-readable storage medium storing computer-executable instructions for performing steps (a) through (e) of the method of claim 37.
